(19) United States
(12) Patent Application Publication
(10) Pub. No.: US 2019/0227414 A1
(43) Pub. Date: Jul. 25, 2019

(54) RETRACTABLE STRAP FOR CAMERA ASSEMBLY

(71) Applicant: Scott Pet Products, Inc., Rockville, IN (US)

(72) Inventors: Joseph E. Umphries, West Terre Haute, IN (US); Jackson E. Ryley, Clinton, IN (US)

(21) Appl. No.: 16/255,673

(22) Filed: Jan. 23, 2019

Related U.S. Application Data
(60) Provisional application No. 62/621,626, filed on Jan. 25, 2018.

(51) Int. Cl. G03B 17/56; F16B 2/08; F16M 13/02; A01M 31/00; A01K 29/00

(52) U.S. Cl. CPC G03B 17/561; F16B 2/08; A01K 29/00; A01M 31/002; F16M 13/022

(57) ABSTRACT

A camera assembly with a retractable strap that is securable to a support such as a tree. The camera assembly includes a camera system, a housing and an elongate, flexible strap. The first end of the strap is coupled with the housing and the second opposite end is freely extending. The strap is incrementally moveable between a storage configuration and an extended configuration such that the freely extending portion has a variable length. A biasing member is coupled with the strap and biases the strap toward its storage configuration. A first connector is disposed on the camera assembly and is releasably engageable with the second end of the strap. The strap is thereby adapted to be extended about the support with the second end releasably secured to the first connector such that the biasing member tightens the strap about the support to thereby mount the camera assembly to the support.

### CROSS REFERENCE TO RELATED APPLICATIONS

This application claims priority under 35 U.S.C. 119(e) of U.S. provisional patent application Ser. No. 62/621,626 filed on Jan. 25, 2018 entitled RETRACTABLE STRAP FOR CAMERA ASSEMBLY the disclosure of which is hereby incorporated herein by reference.

### BACKGROUND OF THE INVENTION

### 1. Technical Field

The present invention relates to cameras and, more specifically, cameras which are intended to operate while unattended and support methods therefor.

### 2. Description of the Related Art

In recent years, cameras which take a picture when triggered by a motion detection device have become quite popular. Such cameras are often referred to as trail cameras or “trailcams” because they are commonly used to capture photographs of wildlife by placing the camera along a game trail. Such trailcams often have the capability of taking either still photographs or short videos and may use infrared bulbs to capture images at night.

While most such cameras use a motion detection device to trigger the capture of an image, other forms of triggering devices may also be employed. For example, when such cameras were first developed, it was known to use a string or other mechanical feature to trigger the capturing of an image. Cameras may also capture an image at a predefined time interval. For example, when a camera is positioned to view a large open area, such a food plot, where animals entering the viewing area are not necessarily in range of a conventional motion detection device, it may be more advantageous to use a camera that takes images at regular time intervals.

Most such cameras capture digital images. The digital images are commonly saved on a removable memory card that the user of the camera removes from the camera device to download the images. Some more recently developed cameras transmit the digital images wirelessly via the same cellular network used by mobile phones or within a local wireless network to a local hub.

Such cameras are used by biologists, nature enthusiasts and, most commonly, by hunters to capture images of wildlife.

While a variety of such cameras are known, they all must be supported and properly positioned at the desired location, and remain in such a position when unattended, to capture the desired images.

Several methods of supporting such cameras are known. One of the most common methods is to use a strap of material to secure the camera to a tree. It is also quite common for users of such trailcameras to periodically reposition the camera. The circumference of the trees to which the trailcamera is mounted will almost certainly be different each time the trailcamera is mounted to a tree. Thus, the length of the strap must be adjusted to secure the trailcamera every time the trailcamera is moved between locations. While attachment buckles that allow the securing length of the strap to be adjusted are known, the use of such buckles can be inconvenient.

It is also known to screw a support structure into a tree to mount a trailcamera on the tree. The use of such screw-in supports, however, damages the tree. Such screw-in support structures also take more time to deploy than conventional straps and are ill-suited for applications where it is expected that the cameras will be repositioned on a regular basis.

A quick and convenient method of securing a camera, such as a trailcamera, to a tree or other support structure remains desirable.

### SUMMARY

The present invention provides a retractable strap assembly that can be employed with a camera system to easily and conveniently mount the camera system to a support such as a tree.

The invention comprises, in one form thereof, a camera assembly securable to a support. The camera assembly includes a camera system and a housing supporting the camera system. The assembly also includes an elongate, flexible strap wherein the strap has a first end coupled with the housing and an opposite, freely extending, second end. The strap is incrementally moveable between a storage configuration and an extended configuration wherein a freely extending portion of the strap terminating at the second end has a variable length. A biasing member is coupled with the strap and biases the strap toward its storage configuration. A first connector is disposed on the camera assembly and is releasably engageable with the second end of the strap. The strap is thereby adapted to be extended about the support with the second end releasably secured to the first connector such that the biasing member tightens the strap about the support to thereby mount the camera assembly to the support.

In some embodiments of the camera assembly the biasing member is a spring. In such embodiments having a spring, the first end of the strap may be secured to a rotatable reel member with the strap being windable onto the reel member whereby the portion of the strap in the storage configuration is wound on the reel member. In some embodiments of a camera assembly having a spring, the spring may take the form of a spiral torsion spring.

In some embodiments of the camera assembly, the second end of the strap has a second connector attached thereto with the second connector being releasably securable to the first connector. In such an embodiment having a second connector, one of the first and second connectors may include a hook and the other one of the first and second connectors may define an opening through which the hook is insertable. In some embodiments having a second connector, the camera assembly further includes a strap housing removably secured to the housing wherein the biasing member, the first end of the strap, and the portion of the strap in the storage configuration are all disposed within the strap housing and wherein the second connector is disposed on the strap housing.

In some embodiments, the camera assembly further includes a strap housing removably secured to the housing wherein the biasing member, the first end of the strap, and the portion of the strap in the storage configuration are all disposed within the strap housing. In such an embodiment having a strap housing, the first end of the strap may be secured to a rotatable reel member with the strap being windable onto the reel member reel whereby the portion of the strap in the storage configuration is wound on the reel member and the reel member is disposed in the strap housing. In such embodiments, the biasing member may take the form of a torsion spring. The second end of the strap may also have a second connector attached thereto with the second connector being releasably securable to the first connector. The first connector may be disposed on the strap housing, the housing of the camera or on a separate mounting bracket.

In some embodiments having a strap housing, the camera assembly includes a mounting bracket removably securable to the housing with the strap housing being secured to the mounting bracket. In such an embodiment, the strap housing may be removably securable to the mounting bracket and the mounting bracket may further define a plurality of engagement surfaces for engaging the support wherein, when the camera assembly is mounted on the support, the plurality of engagement surfaces engage the support and the strap housing is positioned between the support and the housing. In such an embodiment, the plurality of engagement surfaces may take the form of a pair of arcuate surfaces adapted to engage a vertically oriented cylindrical support at vertically spaced positions on the support.

In some embodiments, the camera assembly further includes a locking member operably coupled with the strap wherein the locking member permits both extension and retraction of the strap when in an unlocked position and prevents both extension and retraction of the strap when in a locked position.

In some embodiments, the camera system is configured for unattended image capture. In such embodiments, the camera system may include a motion detection device with the camera system being configured to capture an image when the motion detection device detects motion.

The invention comprises, in another form thereof, a retractable strap assembly for securement to a camera housing. The assembly includes a strap housing releasably securable to the camera housing, either directly or indirectly securable thereto, and an elongate, flexible strap. The strap has a first end coupled with the strap housing and an opposite, freely extending, second end. The strap is incrementally moveable between a storage configuration and an extended configuration whereby a freely extending length of the strap terminating at the second end defines a variable length. A biasing member is coupled with the strap and biases the strap toward its storage configuration. A first connector is disposed on one of the strap housing and the camera housing with the first connector being releasably engageable with the second end of the strap. The strap is thereby adapted to be extended about the support with the second end releasably secured to the first connector such that the biasing member tightens the strap about the support to thereby mount the strap housing and the camera housing to the support.

In some embodiments of the retractable strap assembly, the biasing member is a spring. In such embodiments, the first end of the strap may be secured to a rotatable reel member with the strap being windable onto the reel member whereby the portion of the strap in the storage configuration is wound on the reel member. The spring may also take the form of a spiral torsion spring. Additionally, the second end of the strap may have a second connector attached thereto with the second connector being releasably securable to the first connector. In some of the embodiments, the second connector is adapted to be secured to the camera housing, in other embodiments, the second connector is disposed on the strap housing and in still other embodiments, the second connector is disposed on a mounting bracket.

In some embodiments, the retractable strap assembly further includes a mounting bracket removably securable to the camera housing, the strap housing being secured to the mounting bracket and thereby being indirectly releasably securable to the camera housing. In some embodiments, the strap housing is removably securable to the mounting bracket and in other embodiments, the strap housing is permanently affixed to the mounting bracket.

In some embodiments of the retractable strap assembly that include a mounting bracket, the mounting bracket defines a plurality of engagement surfaces for engaging the support wherein, when the camera housing and retractable strap assembly are coupled together and mounted on the support, the plurality of engagement surfaces engage the support and the strap housing is positioned between the support and the camera housing. In such an embodiment, the plurality of engagement surfaces may take the form of a pair of arcuate surfaces adapted to engage a vertically oriented cylindrical support at vertically spaced positions on the support.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a view of a front view of a camera assembly secured to a tree.

FIG. 2 is a back view of the camera assembly of FIG. 1.

FIG. 3 is a side view of the camera assembly of FIG. 1.

FIG. 4 is a side view of the strap assembly of FIG. 1.

FIG. 5 is a schematic view of a camera system.

FIG. 6 is a view of a reel member, spring and strap.

FIG. 7 is a side view of the reel.

FIG. 8 is a view of one component of the strap housing.

FIG. 9 is a view of a cover member of the strap housing.

FIG. 10 is a side view of the cover member of FIG. 9.

FIG. 11 is a schematic view of a locking mechanism.

FIG. 12 is an exploded perspective view of a camera assembly that has a retractable strap assembly with a mounting bracket.

FIG. 13 is an exploded side view of a camera assembly and support.

FIG. 14 is a rear view of a camera housing and mounting bracket wherein the mounting bracket is in the process of being attached to the camera housing.

FIG. 15 is perspective view of a mounting bracket and strap housing mounted on a camera housing.

FIG. 16 is a perspective view of a retractable strap assembly that includes a mounting bracket.

FIG. 17 is a side view of the assembly of FIG. 16

FIG. 18 is a perspective view of the mounting bracket of FIG. 16.

FIG. 19 is a perspective view of the strap housing of FIG. 16.

FIG. 20 is a perspective view of the main body of the strap housing of FIG. 16.

FIG. 21 is a perspective view of the cover plate of the strap housing of FIG. 16.

FIG. 22 is a perspective view of the reel member of the assembly of FIG. 16.

FIG. 23 is a perspective view of reel cover plate of the assembly of FIG. 16.

Corresponding reference characters indicate corresponding parts throughout the several views. Although the exemplification set out herein illustrates embodiments of the invention, in multiple forms, the embodiments disclosed below are not intended to be exhaustive or to be construed as limiting the scope of the invention to the precise forms disclosed.

### DETAILED DESCRIPTION

A camera assembly 20 secured to a support 22, in the form of a tree, is shown in FIG. 1. In the illustrated embodiment, camera assembly 20 is what is commonly referred to as a trailcam and acquires images while unattended by a user. This type of arrangement allows camera assembly 20 to be positioned where it can capture images of wildlife.

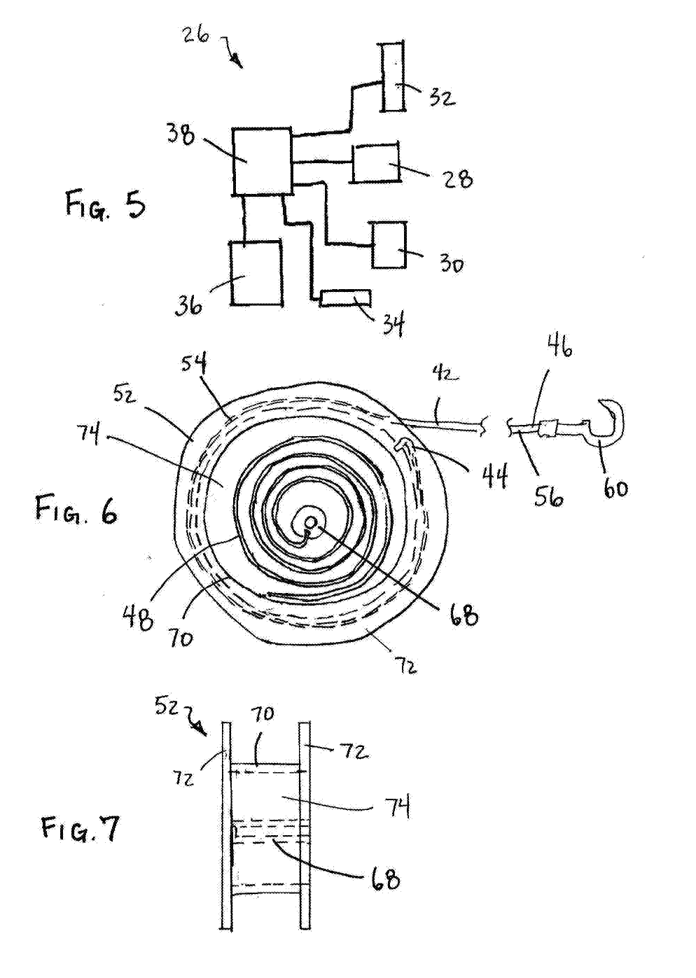

The illustrated camera assembly 20 includes a housing 24 which supports a camera system 26. Camera system 26 is schematically depicted in FIG. 5 and is configured to capture images while unattended. In the illustrated embodiment, camera system 26 includes an image capturing module 28 which includes a lens, a sensor and shutter mechanism for capturing digital images. Camera system 26 also includes a motion detection device 30, LED lamps 32, a user interface 34, a power source 36 and a control module 38. LED lamps 32 may be infrared or other suitable lamps that are used to facilitate the capture of nighttime images. In the illustrated embodiment, user interface 34 is a device for recording images on a removable memory card. Alternatively, user interface 34 could be a transmitter for the wireless transmission of the captured images and other data concerning the status of camera assembly 20. Power source 36 provides electrical power to camera system 26 and may take the form of one or more batteries. Control module 38 controls the operation of camera system and may be a separate component as shown or an integral part of image capturing module 28. In the illustrated embodiment, when motion detection device 30 detects movement, it generates a signal to controller 38 which then causes module 28 to capture an image. Alternative embodiments might rely on a timer to periodically capture images instead of a motion control device and the images captured may be either one or multiple still images or a short duration video. Camera system 26 may take the form of any conventional trailcam system well known to those having ordinary skill in the art.

Housing 24 supports camera system 26. Camera assembly 20 also includes a strap assembly 40 which is secured to the rear of housing 24 and is used to mount camera assembly 20 to tree 22. Strap assembly 40 includes a retractable, elongate, flexible strap 42. A first end 44 of strap 42 is coupled with the camera assembly 20 and the opposite second end 46 of the strap is freely extending and can be withdrawn from strap housing 50. Strap 42 is incrementally moveable between a storage configuration and an extended configuration whereby a freely extending length of strap 42 terminating at second end 46 defines a variable length. A biasing member 48 coupled with strap 42 biases strap 42 toward its storage configuration. In other words, strap 42 can be extended outwardly from its storage position and biasing member 48 acts on strap 42 to retract it back into its storage configuration. In the illustrated embodiment, strap 42 is a flat web of polymeric material, however, strap 42 may take other forms such as a round cord or other suitable form for securing camera assembly 20 to a structure 22.

In the illustrated embodiment, biasing member 48 is a spring that acts on a rotatable reel member 52 to retract strap 42 into strap housing 50. First end 44 of strap 42 is secured to reel member 52. That portion of strap 42 wound about reel member 52 is in the storage configuration 54 and that portion of strap 42 positioned outside of strap housing 50 is in the extended configuration 56. In FIG. 6, reference number 54 indicates that portion of strap 42 in the storage configuration and reference number 56 indicates that portion of strap 42 in the extended configuration.

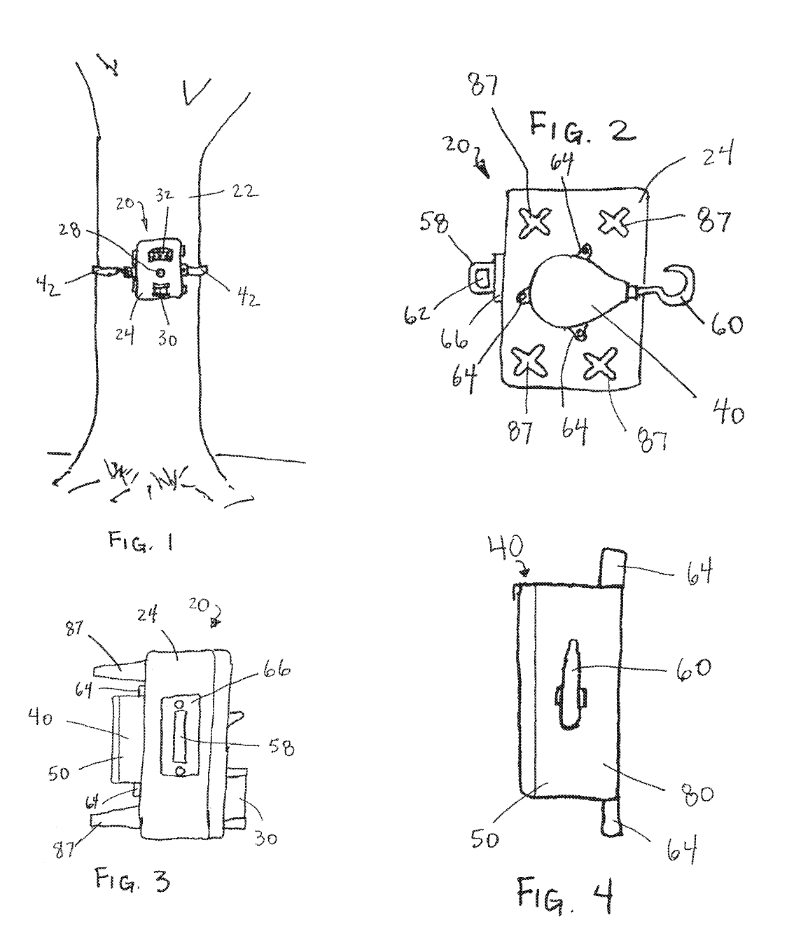

In the embodiment of FIGS. 1-3, camera assembly 20 includes a first connector 58 that is secured to camera housing 24. Second end 46 of strap 42 is releasably engageable with first connector 58 whereby strap 42 can be extended around a support 22 to releasably secure second end 46 with first connector 58 such that the biasing member 48 tightens strap 42 about support 22 to thereby mount camera assembly 20 on support 22 as depicted in FIG. 1.

In the illustrated embodiment, second end 46 of strap 42 has a second connector 60, in the form of a hook, attached thereto. The illustrated first connector 58 takes the form of a bracket with an opening 62 through which hook 60 can be inserted to thereby releasably secure the two connectors 58, 60. Although hook 60 is shown on strap 42, the positions of the two connectors 58, 60 could be reversed with first connector 58 being located on second end 46 of strap 42 instead. It is also noted that a wide variety of alternative connectors could also be employed with the present disclosure. For example, snap-fit buckles, hook and loop fasteners, e.g., Velcro, and any number of other releasable connectors well-known to those having ordinary skill in the art could be employed.

The strap assembly 40 can be disposed within the same housing as the camera system 26, or, the camera system 26 and the strap assembly 40 can have separate housings. An advantage of positioning the strap assembly 40 in the same housing as the camera assembly 26 is that it provides for cost efficient manufacture of the entire assembly. An advantage of using separate housings for the strap assembly 40 and the camera system 26 is that it provides a modular system where one can choose whether or not to employ the retractable strap with the camera housing. The use of separate housings also allows the strap assembly to be secured to pre-existing camera housings to thereby retrofit such camera housings.

In the illustrated embodiments, strap housing 50 is removably secured to housing 24 of camera system 26. To facilitate attachment, strap housing 50 includes projecting tabs 64 with openings. Threaded fasteners are inserted through the openings in tabs 64 to secure strap housing 50 to housing 24. Similarly, first connector 58 has an attachment flange 66 with openings through which threaded fasteners are inserted to secure connector 58 to housing 24.

Although housing 24 advantageously has threaded openings formed therein to receive the threaded fasteners, it may also be possible to use threaded fasteners to attach the housings together in the absence of pre-formed threaded openings in camera housing 24. Alternatively, adhesives or other suitable methods of attachment for securing strap housing 50 and first connector 58 to housing 24 could be employed.

Enclosed within strap housing 50 is biasing member 48, reel member 52, first end 44 of strap 42 and that portion of strap 42 that is in the storage configuration 54 wrapped about reel member 52.

Reel member 52 is shown in FIGS. 6 and 7 and includes a hollow axle 68, a central arbor portion 70 and two outer flanges 72. A toroidal space 74 is defined between the axle 68 and interior of the arbor 70. A shaft 76 located on strap housing 50 is inserted into hollow axle 68 whereby reel member 52 can rotate on shaft 76 relative to strap housing 50. First end 44 of strap 42 is secured to arbor 70 and, when strap 42 is wound about arbor 70, flanges 72 maintain the wound strap on arbor 70.

Biasing member 48 is disposed within toroidal space 74 and acts on reel member 52 to urge the rotation of reel member 52 relative to strap housing 50. In the illustrated embodiment, biasing member 48 is a torsion spring and, more specifically, a spiral torsion spring. One end of biasing member 48 is secured to reel member 52 and the opposite end is secured to strap housing 50. In the illustrated embodiment, one end is secured to axle member 68 and the opposite end is secured to post 78. Various other arrangements of a biasing member may also be used to urge a reel member about which strap 42 is wrapped to retract strap 42 into strap housing 42. For example, the axle on reel member 52 could be disposed in a hollow sleeve on housing 50 with the radially innermost end of a spiral torsion spring attached to the hollow sleeve and the radially outermost end of the spiral torsion spring attached to the inner surface of arbor 70, or, a different type of biasing member could be employed.

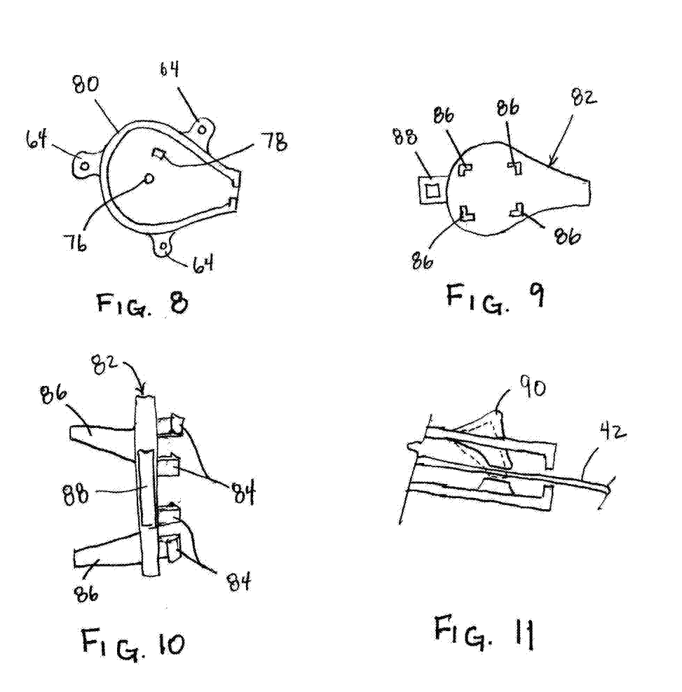

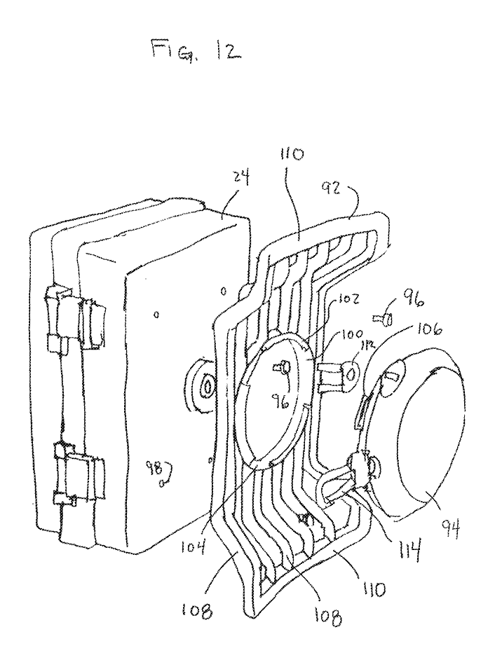

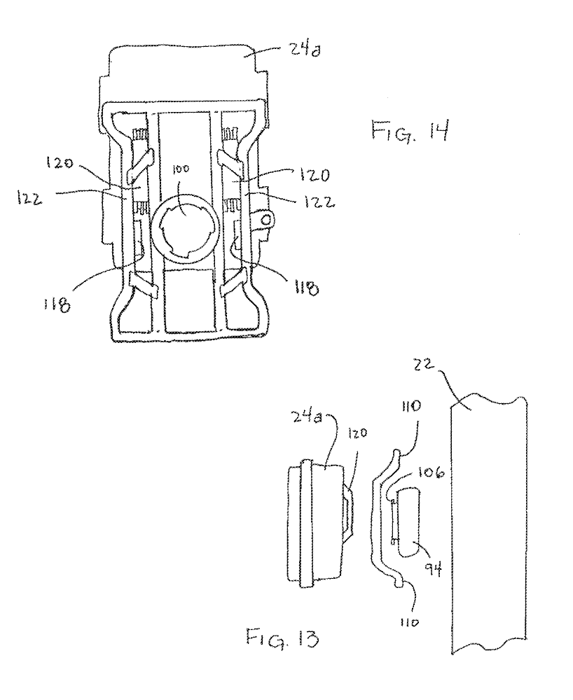

In the illustrated embodiment, strap housing 50 has a main housing member 80 from which tabs 64 extend and which defines the space which receives reel member 52. Main housing member 80 is shown in FIG. 8. A cover member 82 is secured to housing member 80 to complete strap housing 50 and one example of such a cover is shown in FIGS. 9 and 10.

The illustrated cover member 82 includes flexible tabs 84 that engage main housing member 80 to secure cover member 82 thereto. Standoffs 86 project from cover member 82 and help to stabilize camera assembly 20 when it is secured to a support having a generally cylindrical structure. In this regard, it is noted that the embodiment of FIGS. 1-4 does not include standoffs 86 on the strap housing 50 but, instead, relies upon the standoffs 87 located on housing 24.

Another difference between the strap housing of FIGS. 1-4 and cover member 82 is that while the embodiment of FIGS. 1-4 has a first connector 58 that is secured to the housing 24 of camera system 26, the embodiment of FIGS. 9 and 10 has a first connector 88 that is integrally formed with cover member 82.

Another feature that may optionally be included with strap assembly 40 is a locking mechanism as schematically depicted in FIG. 11. The illustrated locking mechanism that includes a locking member which is operably coupled with strap 42 either directly or indirectly. In the illustrated embodiment, locking member 90 is directly coupled with strap 42 and when in the unlocked position shown in solid lines permits strap 42 to be both extended from, and retracted into, strap housing 50. In the locked position, shown in dashed lines, locking member 90 engages strap 42 and prevents both extension and retraction of strap 42. Various other forms of locking mechanisms could alternatively be used with strap 42 including mechanisms that engage reel member 52 instead of strap 42 and are thereby indirectly coupled with strap 42.

When biasing member 48 exerts a sufficiently strong force on strap 42, the use of a locking mechanism is unnecessary. A locking mechanism, however, can be useful to secure strap 42 in a position where it tightly engages the support on which camera assembly 20 is mounted. This can prevent the inadvertent movement or dislodgement of camera assembly 20. Such undesirable movement can occur due to strong winds or when an animal investigates the camera assembly after mounting and comes into contact with the assembly.

While the disclosed camera assembly 20 is well-suited for use as a trailcam and similar applications where it will operate unattended, it may also be employed while a user is present. For example, it is becoming increasingly common for hunters to film their hunts. A hunter generally requires both of their hands to be free during at least portions of the hunt and if a second person is not present to act as a cameraman, it is necessary for the self-filming hunter to find a means to support the camera. The strap assembly 40 and other strap assemblies disclosed herein are well-suited for securing a suitable camera assembly for such applications in addition to situations where the camera will be unattended for extended periods of time.

FIG. 12 shows another embodiment having a camera housing 24 with a camera system 26, a mounting bracket 92 and a retractable strap assembly 94. In this embodiment, mounting bracket 92 is removably securable to camera housing 24 with threaded fasteners 96 which engage threaded bores 98 in camera housing 24. Retractable strap assembly 94 functions in the same manner as retractable strap assembly 40 but has an overall disk shape and is adapted to mount to mounting bracket 92. More specifically, the mounting bracket 94 includes a round mounting socket 100 that includes three helical locking ramps 102 that are circumferentially spaced to thereby define three openings 104. Strap assembly 94 includes a cylindrical projection with three radially outwardly projecting tabs 106 which correspond to openings 104. To mount strap assembly 94 on mounting bracket 92, tabs 106 are inserted through openings 104 and then strap assembly 94 is rotated through an arc of approximately 90 degrees to engage tabs 106 with locking ramps 102 and thereby secure strap assembly 94 to mounting bracket 92. To remove strap assembly 94, it is simply rotated in the opposite direction to return tabs 106 to a point where they align with openings 104 and strap assembly 94 can be disengaged from mounting bracket 92.

Mounting bracket 92 also includes two support arms 108 that project rearwardly from camera assembly 20. An arcuate engagement surface 110 is located at the distal end of each support arm 108. Engagement surfaces 110 are configured to engage a vertically oriented generally cylindrical support, such as the trunk of a tree, with engagement surfaces 110 engaging the support at vertically spaced locations. When the assembly is mounted on a support, e.g., a tree, the strap assembly 92 will be disposed between the support and the camera housing 24.

A connector 112 is integrally formed with mounting bracket 92 and is adapted to engage a connector 114 at the free end of the strap. In the illustrated embodiment, connector 114 is a hook or latch type member and connector 112 defines an opening for engaging connector 114.

FIGS. 13 and 14 show another embodiment of a support member 116. Support member 116 is similar to support member 92 but also includes a pair of tabs 118 that can be used to secure the mounting bracket to camera housing 24a. In this illustrated example, camera housing 24a has integral brackets 120 that can be used with a conventional strap to secure the housing to a support. Mounting bracket 116 is formed out of a resiliently flexible polymeric material and includes a pair of elongate support members 122 that are adapted to be positioned against the back of camera housing 24a. Elongate members 122 can be flexed without breaking and include tabs 118 that can be engaged with brackets 120 on camera housing 24a to secure mounting bracket 116 to camera housing 24a. It is noted that tabs 118 have not yet been inserted into bracket 120 in FIG. 14.

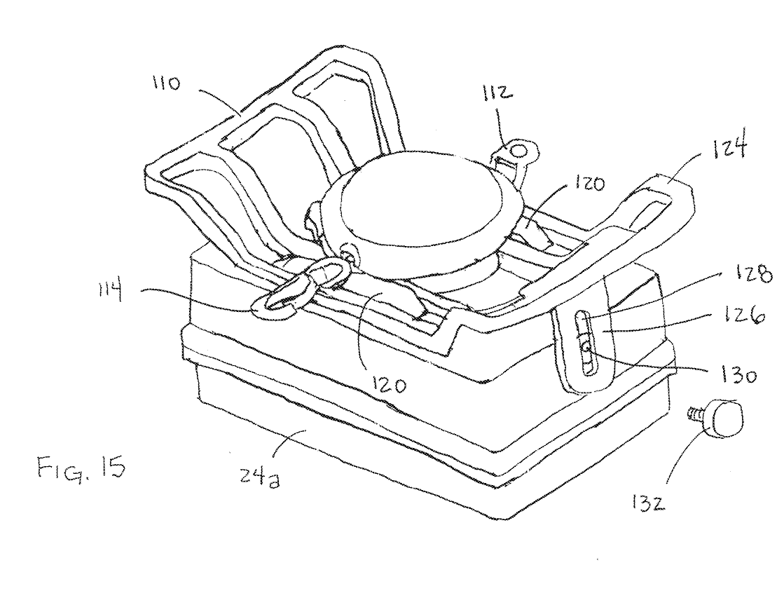

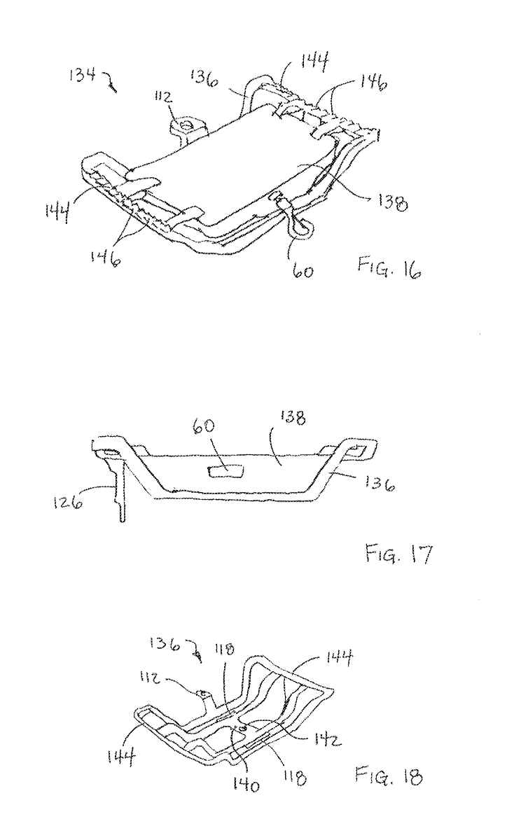

FIG. 15 illustrates a mounting bracket 124 that is similar to mounting bracket 116 but further includes a securement arm 126. Securement arm 126 extends from one of the support arms 108 toward camera housing 24a and engages the bottom surface of housing 24a. Securement arm 126 includes a slot 128 that overlies a threaded bore 130. Threaded bore 130 is similar to threaded bores found on conventional cameras for engaging a threaded fastener on a tripod. Such threaded bores are found on many conventional trail cameras and enable the trail cameras to be used with existing conventional camera mounting equipment. A threaded fastener 132 that mates with bore 130 is inserted through slot 128 and can be used in to secure mounting bracket 124 to camera housing 24a. Advantageously, this method of securing the mounting bracket is combined with mounting tabs 118 to secure mounting bracket 124 to camera housing 24a.

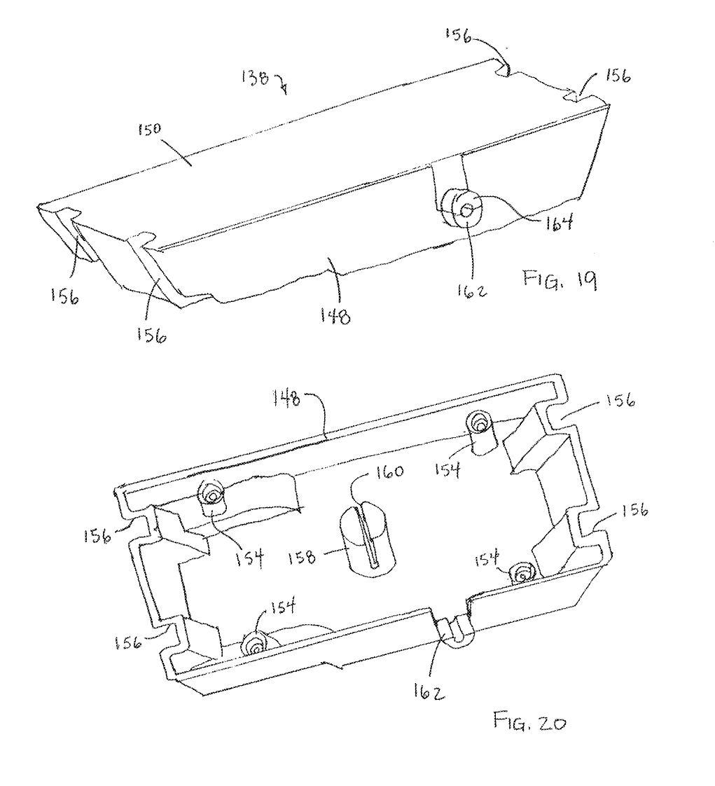

Yet another embodiment of a retractable strap assembly and mounting bracket is depicted in FIGS. 16-23. FIG. 16 illustrates the entire retractable strap assembly 134 which includes both a mounting bracket 136 and a strap housing 138 containing a retractable strap 42. Assembly 134 can be secured to a camera housing having a camera system disposed therein to provide a camera assembly that can be easily mounted to a support.

Mounting bracket 136 is shown in FIG. 18 and includes both tabs 118 and a securement arm 126 for detachably securing mounting bracket 136 to a camera housing 24a having brackets 120 and/or a threaded bore 130 similar to a tripod mount. Mounting bracket 136 also includes a cross piece 140 with an opening 142 through which a threaded fastener can be inserted to engage and secure strap housing 138 to mounting bracket 136. A connector 112 on mounting bracket 136 is releasably engageable with a connector 114 on the end of strap 42. It is also noted that engagement surfaces 144 of mounting bracket 136 include a plurality of short projections 146 that terminate at a point to more firmly engage the support.

Strap housing 138 is depicted in FIGS. 19-21 and includes main body 148 portion and a cover plate 150. Posts 152 extend from cover plate 150 and correspond to posts 154 on main body 148. Threaded fasteners (not shown) extend through a central bore in posts 152 and engage a threaded bore in posts 154 to secure cover plate 150 to main body 148. Each of the main body 148 and cover plate 150 define indentations 156 for receiving support members on mounting bracket 136. An axle 158 extends from main body 148 and includes a slot 160 for engaging one end of a torsion spring. The opposite end of the torsion spring engages reel member 170.

Housing members 148, 150 both define one half of a port 162, 164 through which the strap extends from the housing. The strap port defined by port halves 162, 164 is adapted to feed a strap having a generally round cross section, however, alternative port configurations, such as for a flat tape shaped strap can also be employed depending upon the selected strap design.

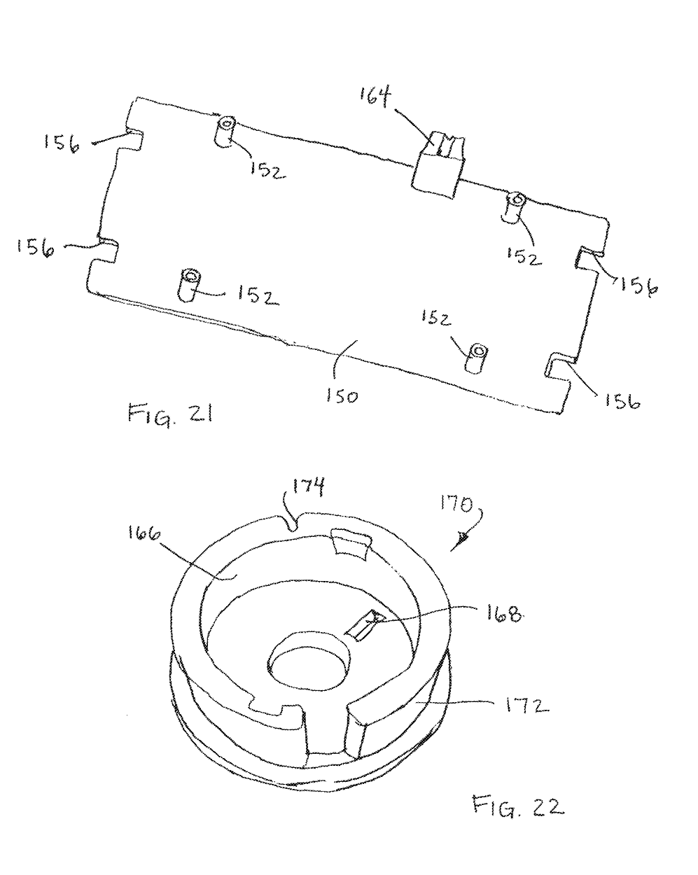

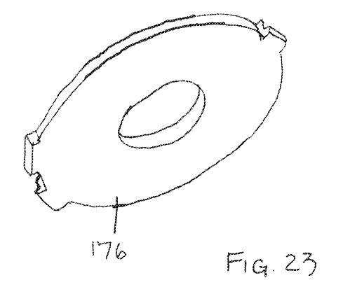

Reel member 170 is shown in FIG. 22 and includes a hollow portion 166 which receives the torsion spring and includes an engagement slot 168 for engaging an end of the spring. Reel 170 also defines a generally cylindrical wall 172 that acts as an arbor. One end of the strap is secured to slot 174 and the strap is wound about the exterior surface of wall 172.

A spring cover plate 176 is secured to reel member 170 to contain the torsion spring within hollow portion 166 after it has been installed. Spring cover plate 176 includes a pair of latches 178 that engage corresponding features on reel member 170 to secure it in place. A radially extending tab on plate 176 fits an opening in wall 172.

While this invention has been described as having an exemplary design, the present invention may be further modified within the spirit and scope of this disclosure. This application is therefore intended to cover any variations, uses, or adaptations of the invention using its general principles.

What is claimed is:

1. A camera assembly securable to a support, the camera assembly comprising:
a camera system;
a housing supporting the camera system;
an elongate, flexible strap, the strap having a first end coupled with the housing and an opposite, freely extending, second end, the strap being incrementally moveable between a storage configuration and an extended configuration whereby a freely extending length of the strap terminating at the second end defines a variable length;
a biasing member coupled with the strap and biasing the strap toward its storage configuration; and
a first connector disposed on the camera assembly, the first connector being releasably engageable with the second end of the strap whereby the strap is adapted to be extended about the support with the second end releasably secured to the first connector such that the biasing member tightens the strap about the support to thereby mount the camera assembly to the support.

2. The camera assembly of claim 1 wherein the biasing member is a spring.

3. The camera assembly of claim 2 wherein the first end of the strap is secured to a rotatable reel member with the strap being windable onto the reel member whereby the portion of the strap in the storage configuration is wound on the reel member.

4. The camera assembly of claim 2 wherein the spring is a spiral torsion spring.

5. The camera assembly of claim 1 wherein the second end of the strap has a second connector attached thereto, the second connector being releasably securable to the first connector.

6. The camera assembly of claim 5 wherein one of the first and second connectors includes a hook and the other one of the first and second connectors defines an opening through which the hook is insertable.

7. The camera assembly of claim 1 further comprising a strap housing removably coupled with the housing wherein the biasing member, the first end of the strap, and the portion of the strap in the storage configuration are all disposed within the strap housing.

8. The camera assembly of claim 7 wherein the first end of the strap is secured to a rotatable reel member with the strap being windable onto the reel member reel whereby the portion of the strap in the storage configuration is wound on the reel member, the reel member being disposed in the strap housing.

9. The camera assembly of claim 8 wherein the biasing member is a torsion spring.

10. The camera assembly of claim 9 further comprising a mounting bracket removably securable to the housing, the strap housing being secured to the mounting bracket.

11. The camera assembly of claim 10 wherein the second end of the strap has a second connector attached thereto, the second connector being releasably securable to the first connector and wherein the first connector is disposed on the mounting bracket.

12. The camera assembly of claim 10 wherein the strap housing is removably securable to the mounting bracket and the mounting bracket defines a plurality of engagement surfaces for engaging the support wherein, when the camera assembly is mounted on the support, the plurality of engagement surfaces engage the support and the strap housing is positioned between the support and the housing.

13. The camera assembly of claim 12 wherein the plurality of engagement surfaces comprise a pair of arcuate surfaces adapted to engage a vertically oriented cylindrical support at vertically spaced positions on the support.

14. The camera assembly of claim 1 further comprising a locking member operably coupled with the strap, the locking member permitting both extension and retraction of the strap when in an unlocked position and preventing both extension and retraction of the strap when in a locked position.

15. The camera assembly of claim 1 wherein the camera system is configured for unattended image capture.

16. The camera assembly of claim 13 wherein camera system includes a motion detection device and wherein the camera system is configured to capture an image when the motion detection device detects motion.

17. A retractable strap assembly for securement to a camera housing, the retractable strap assembly comprising:
a strap housing releasably securable to the camera housing;
an elongate, flexible strap, the strap having a first end coupled with the strap housing and an opposite, freely extending, second end, the strap being incrementally moveable between a storage configuration and an extended configuration whereby a freely extending length of the strap terminating at the second end defines a variable length;
a biasing member coupled with the strap and biasing the strap toward its storage configuration; and
a first connector coupled with one of the retractable strap assembly and the camera housing, the first connector being releasably engageable with the second end of the strap whereby the strap is adapted to be extended about the support with the second end releasably secured to the first connector such that the biasing member tightens the strap about the support to thereby mount the strap housing and the camera housing to the support.

18. The retractable strap assembly of claim 17 wherein the biasing member is a torsion spring coupled with a rotatably reel member and the first end of the strap is secured to the rotatable reel member with the strap being windable onto the reel member whereby the portion of the strap in the storage configuration is wound on the reel member.

19. The retractable strap assembly of claim 17 further comprising a mounting bracket removably securable to the camera housing, the strap housing being secured to the mounting bracket.

20. The retractable strap assembly of claim 19 wherein the strap housing is removably securable to the mounting bracket.

21. The retractable strap assembly of claim 19 wherein the mounting bracket defines a plurality of engagement surfaces for engaging the support wherein, when the camera housing and retractable strap assembly are coupled together and mounted on the support, the plurality of engagement surfaces engage the support and the strap housing is positioned between the support and the camera housing.

22. The retractable strap assembly of claim 21 wherein the plurality of engagement surfaces comprise a pair of arcuate surfaces adapted to engage a vertically oriented cylindrical support at vertically spaced positions on the support.

23. The retractable strap assembly of claim 19 wherein the second end of the strap has a second connector attached thereto, the second connector being releasably securable to the first connector and wherein the first connector is disposed on the mounting bracket.
